(19) United States
(12) Patent Application Publication
(10) Pub. No.: US 2019/0031930 A1
(43) Pub. Date: Jan. 31, 2019

(54) SYSTEMS AND METHODS FOR CURING AN ULTRAVIOLET ADHESIVE WITHIN A CONTAINER

(71) Applicants: Valeriy Zolotykh, Abington, MA (US); Anil Jeswani, Acton, MA (US); Janet Milliez, Cambridge, MA (US)

(72) Inventors: Valeriy Zolotykh, Abington, MA (US); Anil Jeswani, Acton, MA (US); Janet Milliez, Cambridge, MA (US)

(73) Assignee: LEDVANCE LLC, Wilmington, MA (US)

(21) Appl. No.: 15/663,031

(22) Filed: Jul. 28, 2017

(51) Int. Cl. C09J 163/00

(52) U.S. Cl. CPC C09J 163/00; F21K 9/232

(57) ABSTRACT

A system for curing an ultraviolet adhesive located within a container may include a container. The container may include a base having a first mating surface disposed along the base. A cover may include a second mating surface. The ultraviolet adhesive may be located between the first mating surface and the second mating surface. An ultraviolet LED may be located within the base and is configured to emit ultraviolet light to cure the ultraviolet adhesive.

### FIELD

The present disclosure generally relates to curing an adhesive and, more particularly, is related to curing an ultraviolet adhesive within a container.

### BACKGROUND

Adhesives generally may be dispensed inside a container for cosmetic reasons, as to prevent visibility of the adhesive to a user. Ultraviolet adhesives generally may be used to mate surfaces because of their ease to apply, and ultraviolet adhesives generally may not emit harmful vapors that could damage sensitive electronic components. However, to properly cure the ultraviolet adhesive and achieve a desired bonding strength, the ultraviolet adhesive requires curing with exposure to a sufficient irradiance of ultraviolet light.

Curing an adhesive that is located within the housing of a container may be difficult, as a container may contain materials that are not transparent to ultraviolet light or otherwise hinder the irradiance of ultraviolet light. When materials of a container block at least some of the irradiance of ultraviolet light onto the ultraviolet adhesive, it may take a longer period of time for ultraviolet light irradiated from outside of the container to cure the ultraviolet adhesive or otherwise impede proper curing, which may create a burden on manufacturing processes. A more efficient and less time-consuming option to cure an ultraviolet adhesive located within a container is needed.

Thus, a heretofore unaddressed need exists in the industry to address the aforementioned deficiencies and inadequacies.

### SUMMARY

In light of the foregoing, the present disclosure generally relates to systems and methods for curing an ultraviolet adhesive located within a container. Generally, with reference to the structure of the system for curing an ultraviolet adhesive within a container, the container may include a base that may include a first mating surface disposed along the base. The container may include a cover having a second mating surface. The ultraviolet adhesive may be located between the first and second mating surfaces. An ultraviolet LED may be located within the base and may be configured to emit ultraviolet light to cure the ultraviolet adhesive.

Generally, with reference to the structure of the system for curing an adhesive within an LED module, the LED module may include a base including a first mating surface disposed along the base. The LED module may include a cover having a second mating surface engaged with the first mating surface. The ultraviolet adhesive may be located between the first and second mating surfaces. At least one visible spectrum LED may be located within the base and is configured to emit visible light. At least one ultraviolet LED may be located within the base and may configured to emit ultraviolet light onto the ultraviolet adhesive to cure the ultraviolet adhesive.

Generally, the method for curing an ultraviolet adhesive within a container may contain the step of: applying the ultraviolet adhesive to a mating surface of the container. The container may include a base having a first mating surface located along a base. The container may include an ultraviolet LED located within the base. The container may include a cover having a second mating surface. The method may include engaging the first mating surface and the second mating surface. The method may include emitting ultraviolet light using the ultraviolet LED to cure the ultraviolet adhesive.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The present disclosure can be better understood with reference to the following drawings. The components of the drawing are not necessarily to scale, emphasis instead being placed upon clearly illustrating the principles of the present disclosure. Moreover, in the drawings, like referenced numbers designate corresponding parts throughout the several views.

FIG. 1 is a cutaway perspective view of a system for curing an ultraviolet adhesive within a container, in accordance with a first exemplary embodiment of the present disclosure.

FIG. 2 is a cutaway perspective view of a system for curing an ultraviolet adhesive within a LED module, in accordance with a second exemplary embodiment of the present disclosure.

FIG. 3 is cross-sectional view of the LED module as illustrated in FIG. 2, in accordance with the second exemplary embodiment of the present disclosure.

FIG. 4 is a flowchart illustrating a method for curing an ultraviolet adhesive within a container, in accordance with the first exemplary embodiment of the present disclosure.

### DETAILED DESCRIPTION

The present disclosure generally relates to curing an adhesive and, more particularly, is related to curing an ultraviolet (also known as “UV”) adhesive within a container. It should be noted that, while the following provides a series of examples of the ultraviolet adhesive curing systems, methods, and its components, other configurations may be utilized without departing from the scope of the claims.

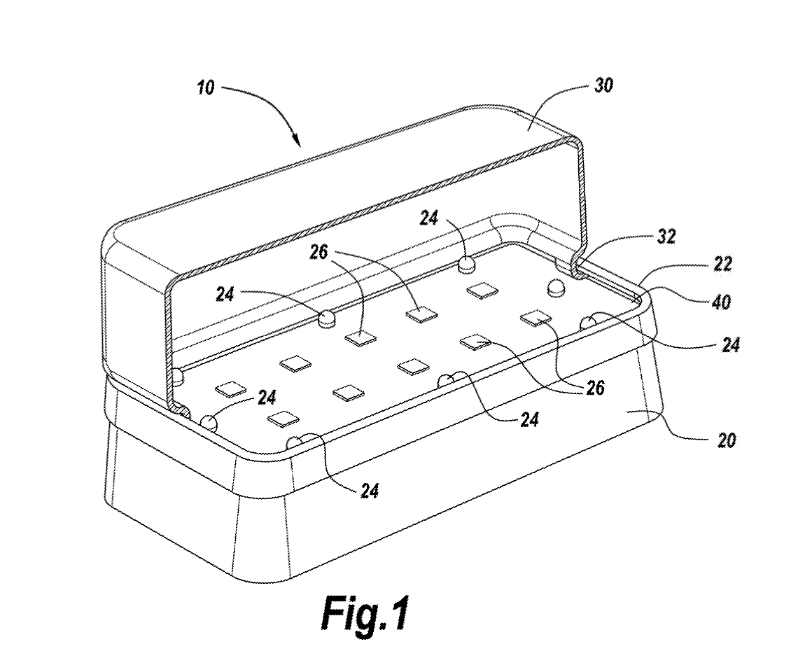

FIG. 1 is a perspective view of a system for curing an ultraviolet adhesive 40 within a container 10, in accordance with a first exemplary embodiment of the present disclosure. The container 10 may include a base 20. The base 20 may be made from metal, plastic, glass, or any other suitable material known in the art. The base 20 may comprise a first mating surface 22. The first mating surface 22 may be a lip, slotted member, or perimeter surface of the base 20 configured to contact a second mating surface 32.

As illustrated in FIG. 1, the container 10 may include a cover 30. The cover 30 may include the second mating surface 32. The second mating surface 32 may comprise a lip, perimeter surface, or other known surface on the cover 30 configured to contact the first mating surface 22. The cover 30 may comprise a plastic, glass, opaque or transparent acrylic, opaque or transparent polycarbonate material, or a similar material.

For example, materials such as acrylic or a diffusive polycarbonate generally provide low transmission rates of ultraviolet light, obscuring the contents of the container relative to outside sources of ultraviolet light when the first mating surface 22 and second mating surface 32 are in contact. Providing low transmission rates of ultraviolet light may make it difficult to irradiate ultraviolet light onto the ultraviolet adhesive 40 through the cover 30 using external ultraviolet light sources, such as an ultraviolet spot cure gun. This may lead to an undesirable prolonged curing time of the ultraviolet adhesive 40 using ultraviolet light from outside the container 10, which may burden manufacturing time and resources or it may require use of a less desirable adhesive.

The ultraviolet adhesive 40 may be disposed between the first mating surface 22 and the second mating surface 32. The ultraviolet adhesive 40 may be applied to the first mating surface 22 and/or the second mating surface 32. The ultraviolet adhesive 40 may be located within the container 10 to provide an optimal bond between the first mating surface 22 and second mating surface 32. While the first mating surface 22 and second mating surface 32 are illustrated in FIG. 1 with a vertical orientation, the surfaces may be horizontal, angled, curved or in other positions without deviating from the scope of the present disclosure. The first mating surface 22 and the second mating surface 32 may be removably mechanically engageable, such that the ultraviolet adhesive 40 impedes disengagement and both the ultraviolet adhesive and the mechanical engagement operate to maintain engagement of the base 20 and cover 30. The first mating surface 22 and the second mating surface 32 may be helically threaded or provide a fiction fit or other known means for mechanical engagement.

The ultraviolet adhesive 40 may be an epoxy or other single component adhesive that is cured by ultraviolet light. It may be advantageous to utilize an ultraviolet adhesive 40, as many other industrial adhesives produce vapors that either are environmentally harmful or damage the components within the container 10.

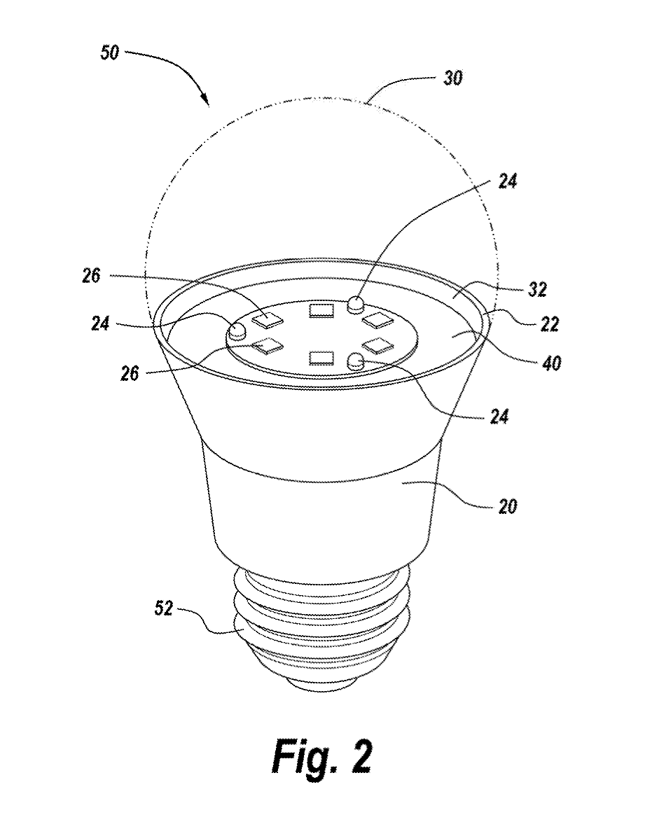

As shown in FIG. 1 and FIG. 2, an ultraviolet LED 24 may be located within the base 20 and may emit ultraviolet light onto the ultraviolet adhesive 40, thereby curing the ultraviolet adhesive 40. A plurality of ultraviolet LEDs 24 may be disposed within the container 10. The ultraviolet LED 24 may be located substantially subjacent to the ultraviolet adhesive 40, first mating surface 22 and second mating surface 32. The ultraviolet LED 24 may be located substantially adjacent to the ultraviolet adhesive 40, first mating surface 22 and second mating surface 32.

The ultraviolet LED 24 may be in close proximity to the ultraviolet adhesive 40, as to allow for the ultraviolet adhesive 40 to receive an effective irradiance of ultraviolet light from the ultraviolet LED 24 without having to penetrate the cover 30 or other obfuscating materials. This design may be advantageous, as the ultraviolet LED 24 may emit ultraviolet light onto the ultraviolet adhesive 40 without having to go through the material of the container 10 such as the cover 30. This arrangement may allow for the ultraviolet adhesive 40 to receive a high irradiance of ultraviolet light, and cure the ultraviolet adhesive 40 efficiently. The container 10 may also include a visible spectrum LED 26 located on the base 20 configured to emit visible spectrum light through the cover 30.

FIG. 2 is a cutaway perspective view of a system for curing an ultraviolet adhesive 40 within an LED module 50, in accordance with a second exemplary embodiment of the present disclosure. Specifically, FIG. 2 illustrates the LED module 50 having a base 20 and a cover 30 and a portion of the cover 30 is cut out of the illustration to better illustrate the unique elements of the disclosure. The base 20 may comprise a first mating surface 22. The first mating surface 22 may be disposed along the base 20, where the first mating surface 22 comprises a lip, slot, or edge to engage with the second mating surface 32 to create a mechanical fit or connection between base 20 and cover 30. The connection between base 20 and cover 30 may be seamless and in-line for aesthetic purposes as desired. The connection between the base 20 and the cover 30 may be visually obscured from perception outside the LED module 50 for aesthetic purposes.

The cover 30 may include a second mating surface 32 that may be engaged to the first mating surface 22 using an ultraviolet adhesive 40. The cover 30 may comprise a plastic, glass, acrylic or polycarbonate material that may be transparent to visible-spectrum light and opaque to ultraviolet-spectrum light. The ultraviolet adhesive 40 may be located between the first mating surface 22 and second mating surface 32 within the LED module 50 and cured with ultraviolet light.

At least one ultraviolet LED 24 may be located within the LED module 50 and may be configured to emit ultraviolet light onto the ultraviolet adhesive 40 and cure the ultraviolet adhesive 40. The ultraviolet LED 24 may emit ultraviolet light in the ultraviolet spectral range. The ultraviolet LED 24 may emit ultraviolet light in the wavelength range of about 360 nanometers to about 405 nanometers. The ultraviolet LED 24 may emit ultraviolet light with a radiant power density ranging from about 1-10 W/cm2. The LED module 50 may include at least one visible spectrum LED 26 disposed integral with the base 20. The visible spectrum LED 26 may be configured to emit a visible light. The visible spectrum LED 26 may be configured to emit both visible light and ultraviolet light. A threaded contact 52 may be integral with the base 20. The threaded contact 52 may be configured to provide an electrical path to power the ultraviolet LED 24 and the visible spectrum LED 26 from an outside power source (not shown).

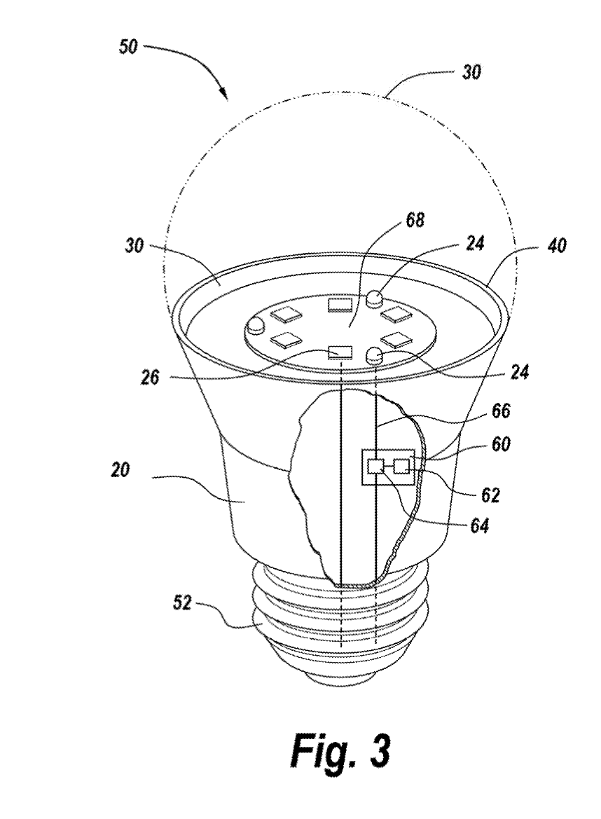

FIG. 3 is cross-sectional view of the LED module as illustrated in FIG. 2, in accordance with the second exemplary embodiment of the present disclosure. The first mating surface 22 may be disposed along the base 20, where the first mating surface 22 comprises a lip, slot, or edge to engage with the second mating surface 32 to create a mechanical fit or connection between base 20 and cover 30. The electrical socket 52 may be in electrical communication with the ultraviolet LED 24. The electrical socket 52 may be connected to the base 20 of the LED module 50. The electrical socket 52 may include wires, cables, or another known component to conduct electrical current to the ultraviolet LED 24. A visible spectrum LED 26 may be in electrical communication with the electrical socket 52 using wires, cables, or another known component. The electrical socket 52 may be in electrical communication with an external power source (not shown) to provide electricity to the LED module 50.

As illustrated in FIG. 3, the LED module 50 may contain an electrical circuit 60. The electrical circuit may include a timer 62 and a fuse 64. The timer 62 and fuse 64 may be configured to permanently disconnect the ultraviolet LED 24 from the electrical socket 52 after a period of time. The timer 62 may be set to a pre-determined time known to coincide with the time required for the ultraviolet adhesive to cure. The fuse 64 may respond to the timer 62, and the fuse 64 may permanently disable a wire 66 connecting the ultraviolet LED 24 to the electrical socket 52.

The connection between the ultraviolet LED 24 and electrical socket 52 may be disconnected as desired to provide a higher energy efficiency for the LED module 50. It may be desirable to keep the ultraviolet LED 24 on after the curing process, as ultraviolet light can provide additional spectral power density to the LED module 50, and the ultraviolet light may enhance the appearance of white objects in the view of the LED module 50. The ultraviolet LED 24 may be configured to be set to a lower intensity after the ultraviolet adhesive 40 has been cured for achieving a higher efficiency LED module 50 while emitting ultraviolet light to enhance the appearance of objects in the view of the LED module 50.

The ultraviolet LED 24 may be located within the base 20. The ultraviolet LED 24 may be located substantially subjacent to the ultraviolet adhesive 40. The ultraviolet LED 24 may be located substantially adjacent to the ultraviolet adhesive 40. The base 20 may include a light guide module 68 to direct ultraviolet light optically to the ultraviolet adhesive 40. The light guide module 68 may comprise an optical fiber, lens array, optical condenser or a known light guide that directs ultraviolet light onto the ultraviolet adhesive 40 for a preferred irradiance onto the ultraviolet adhesive 40.

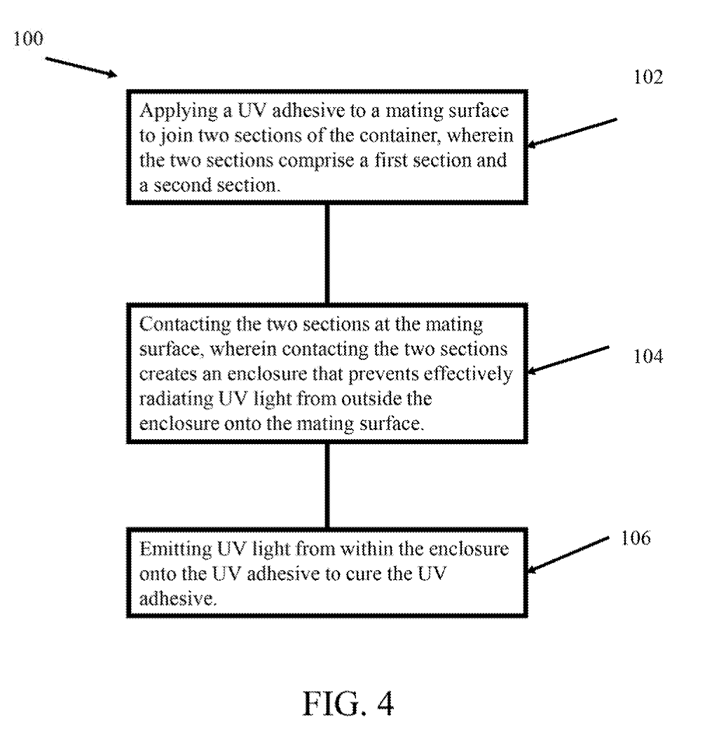

FIG. 4 is a flowchart illustrating a method for curing the ultraviolet adhesive within a container 10 shown in FIG. 1, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, an ultraviolet adhesive 40 may be applied to a mating surface to join two sections of the container 10, wherein the two sections comprise a first section and a second section. The two sections at the mating surface contact, wherein contacting the two sections creates an enclosure that prevents effectively radiating UV light from outside the enclosure onto the mating surface. (block 104). The UV adhesive is cured by emitting UV light from within the enclosure onto the UV adhesive 40. (block 106). The method may include disconnecting an electrical socket 52 from the ultraviolet LED 24. The disconnecting step may include using a timer 62 and a fuse 64 to disconnect the electrical socket 52 from the ultraviolet LED 24.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect, the disclosed methods and systems.

It should be emphasized that the above described embodiments of the present disclosure are merely some possible examples of implementations, set forth for a clear understanding of the principles of the disclosure. Many variations and modifications may be made to the above described embodiments of the disclosure without departing substantially from the spirit and principles of the disclosure. All such modifications and variations are intended to be included herein within the scope of this disclosure and the present disclosure, and protected by the following claims.

What is claimed is:

1. A system for providing ultraviolet curing within an enclosure, the system comprising:
a container having a base and a cover;
the base comprising a first mating surface disposed along the base;
the cover comprising a second mating surface compatible with the first mating surface;
an ultraviolet adhesive disposed between the first mating surface and the second mating surface; and
an ultraviolet LED disposed within the container positioned to irradiate ultraviolet light to the ultraviolet adhesive.

2. The system of claim 1, further comprising at least one visible spectrum LED disposed within the container configured to emit visible light.

3. The system of claim 1, wherein the first mating surface and the second mating surface are mechanically engaged.

4. The system of claim 1, further comprising:
a power source; and
a fuse within the base connecting the power source to the ultraviolet LED; whereby the fuse is configured to permanently disconnect the ultraviolet LED from the power source after ultraviolet adhesive is cured.

5. The system of claim 1, wherein the ultraviolet LED is disposed substantially subjacent to the first mating surface and the second mating surface.

6. The system of claim 1, wherein the ultraviolet LED is disposed substantially adjacent to the first mating surface and the second mating surface.

7. The system of claim 1, further comprising a light guide module to optically direct the ultraviolet light from the ultraviolet LED to the ultraviolet adhesive.

8. The system of claim 1, wherein the cover is transparent and wherein the ultraviolet adhesive is optically obscured from outside the container.

9. The system of claim 1, wherein the ultraviolet adhesive comprises an epoxy.

10. A system for enclosing an LED module, the LED module comprising:
a base comprising a first mating surface disposed along a portion of the base;
a cover comprising a second mating surface disposed along a portion of the cover, the second mating surface abutting the first mating surface;
an ultraviolet adhesive disposed between the first mating surface and the second mating surface;
at least one visible spectrum LED connected to the base configured to emit visible light through the cover; and
at least one ultraviolet LED connected to the base configured to emit ultraviolet light onto the ultraviolet adhesive thereby curing the ultraviolet adhesive.

11. The system of claim 10, wherein the cover and the base are mechanically engaged.

12. The system of claim 10, further comprising:
a power source; and
a fuse within the base connecting the power source to the ultraviolet LED; whereby the fuse is configured to permanently disconnect the ultraviolet LED from the power source after the ultraviolet adhesive is cured.

13. The system of claim 10, wherein the at least one ultraviolet LED is disposed substantially subjacent to the ultraviolet adhesive.

14. The system of claim 10, wherein the at least one ultraviolet LED is disposed substantially adjacent to the ultraviolet adhesive.

15. The system of claim 10, further comprising a light guide module to optically direct the ultraviolet light from the at least one ultraviolet LED to the ultraviolet adhesive.

16. A method for forming a container, comprising:
applying an ultraviolet adhesive to a mating surface to join at least two sections of the container, wherein the two sections comprise a first section and a second section;
contacting the two sections of the container at the mating surface, wherein contacting the two sections creates an enclosure that prevents a ultraviolet light source exterior to the enclosure from emitting ultraviolet light onto the onto the ultraviolet adhesive;
emitting ultraviolet light from an the ultraviolet LED located within the enclosure to cure the ultraviolet adhesive.

17. The method of claim 16, further comprising disconnecting the ultraviolet LED from a power source after the ultraviolet adhesive is cured.

18. The method of claim 17, wherein the disconnecting step comprises a fuse connecting the power source to the ultraviolet LED configured to disconnect the ultraviolet LED after a predetermined period of time.

19. The method of claim 16, wherein the step of contacting the two sections further comprises mechanically engaging the two sections together.
